(19) United States
(12) Patent Application Publication
(10) Pub. No.: US 2012/0186086 A1
(43) Pub. Date: Jul. 26, 2012

(54) METHOD FOR BANK EQUIPMENT REINFORCEMENT AND FIXATION THROUGH AN ANCHORAGE BASE

(76) Inventor: Nelson TAVARES DE PINHO, Sao Paulo (BR)

(21) Appl. No.: 13/010,246

(22) Filed: Jan. 20, 2011

(51) Int. Cl. B23P 17/00

(52) U.S. Cl. 29/897.34

(57) ABSTRACT

“METHOD FOR BANK EQUIPMENT REINFORCEMENT AND FIXATION THROUGH AN ANCHORAGE BASE”, which is intended for the reinforcement and clamping of ATMS and “Cash Dispensers” type equipment, being characterized by envisioning the installation of jackets (1) in the said equipment, being that the said jackets (1) are protective plates installed in the safes, being basically composed by a box (2) made of Metal plate, having material layers in its internal part having the objective to provide resistance against burglary, being the first layer of material contained in the box (2) forming the jacket (1) a chemical compound (3) providing resistance against the effects of a blow torch while the second layer is preferably produced with concrete (4), providing mechanical strength to the parts; the chemical protection which constitutes the layer (3) is, essentially, a flammable compound, preferably containing bitumen, pitch and sulfur at duly specified layer amounts and thicknesses; in its turn, layer (4), which constitutes the mechanical protection is preferably obtained with reinforced concrete containing cement, aluminum oxide with a number of granulations and steel stretched wires, at the specified amounts.

This description report is related to an Invention Privilege patent which proposes a new method for the reinforcement and clamping of bank equipment, commonly known as ATM, as well as cash dispensing equipment, also known as Cash Dispenser.

This method has, as its general purpose, to provide an increasing on the safety of such equipment, making them substantially more resistant against robbery, depredation attempts and similar actions.

As it is generally known, bank institutions, over several years have made available a number of facilities to their customers, such as the ATMs, which are self-service external facilities where a number of operations can be conducted, being cash withdrawal one of the most executed.

Bank institutions also make equipment known as “Cash Dispenser” available, allowing cash withdrawal and other operations and which can be installed in large public circulation places.

In general, both ATM type installations and “Cash Dispensers” have a construction project which shall provide safety against sinister attempts.

It happens that, recently, there have been a significant increase in violence rates, particularly in large urban centers, there's a clear demonstration that the currently used equipments do not provide an appropriate safety level suitable to the techniques used by specialized gangs.

Facing such context, the material described in this Invention Privilege patent, relating to a method for the internal and external structure reinforcement, as well as the clamping and safety means, which are applicable both to ATMs and also to “Cash Dispensers”, has been developed in order to make such equipment sufficiently safe.

The method described herein basically shows the main characteristics or approaches to the problem which represents the state of art to be considered in this case, being: a) a set of external armors and an internal armor which can be joined to the equipment structure; b) the improvement of equipment's door locking device; and c) a system intended to anchor the equipment in a base, a clamping set (fixing kit) and an anchorage set (anchorage kit).

This Invention Privilege patent may be better understood, in all its technical and functional characteristics, through the detailed description that will be conducted based on the drawings listed below, which, for explanation and non-limiting purposes, may be viewed in the following figures, where:

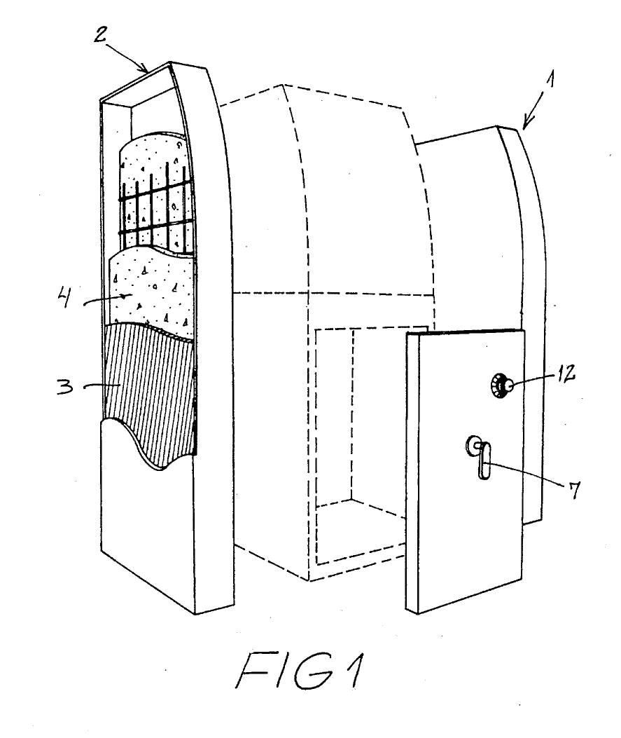

FIG. 1 depicts a general schematic view of a “cash dispenser” type equipment, where armor reinforcement are incorporated, as well as door duly equipped with the locking system herein proposed;

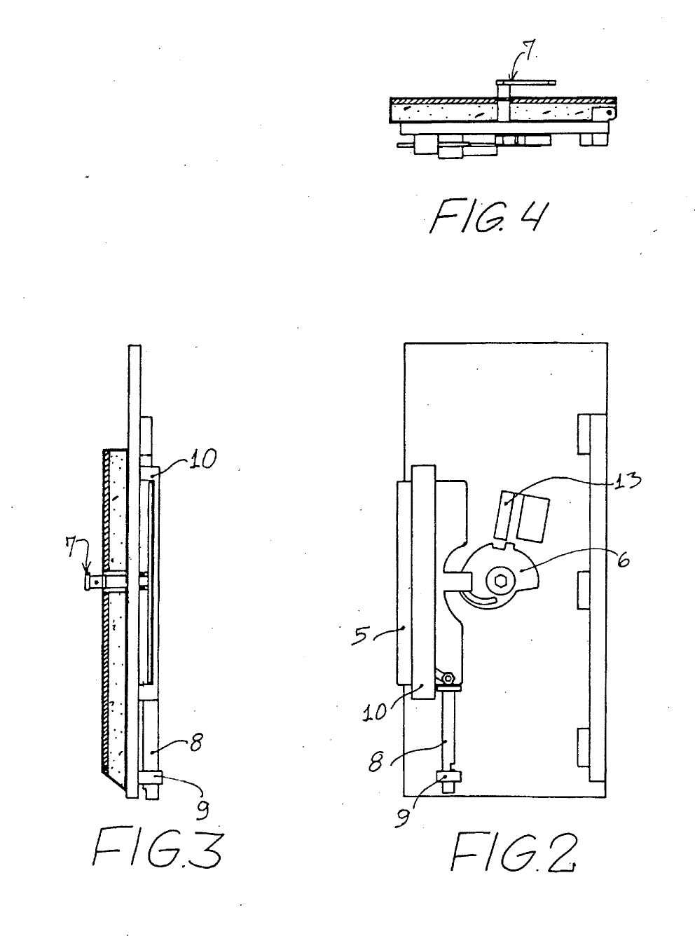

FIG. 2 depicts the equipment's door general and internal view, as described in FIG. 1;

FIG. 3 depicts a view projected from FIG. 2, showing the said door side view;

FIG. 4 depicts a view which is also projected from FIG. 2, where the upper region of the said door can be noted;

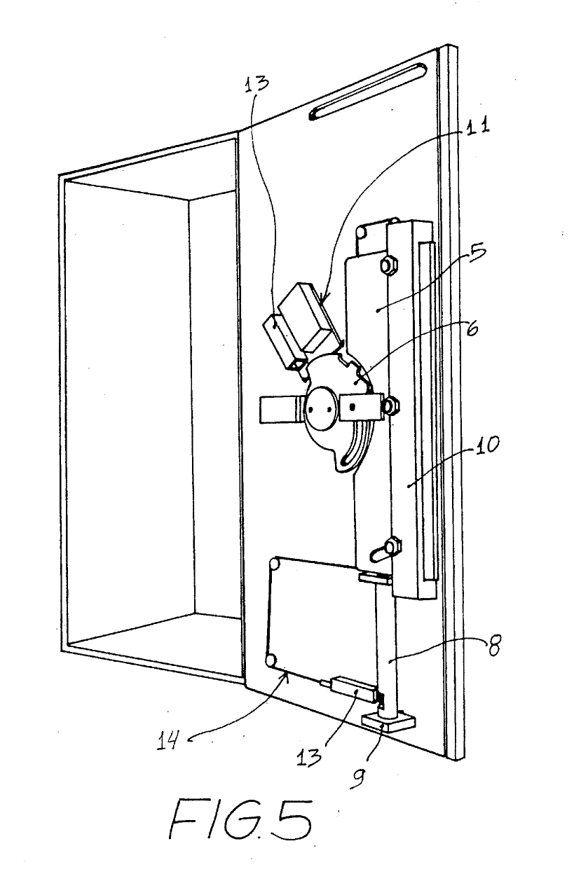

FIG. 5 depicts an schematic detail taken from FIG. 1, where the said door is described in its total opening condition;

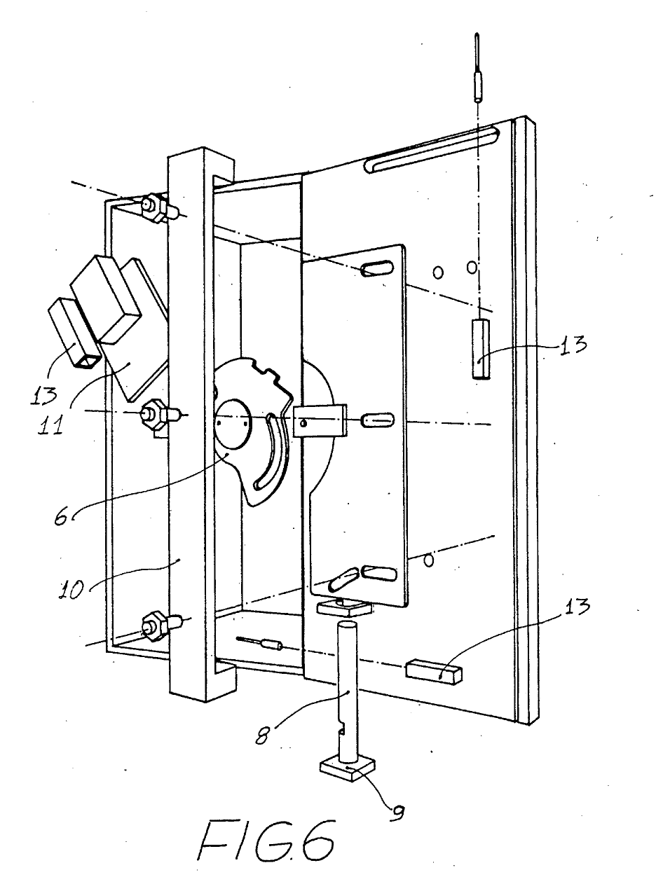

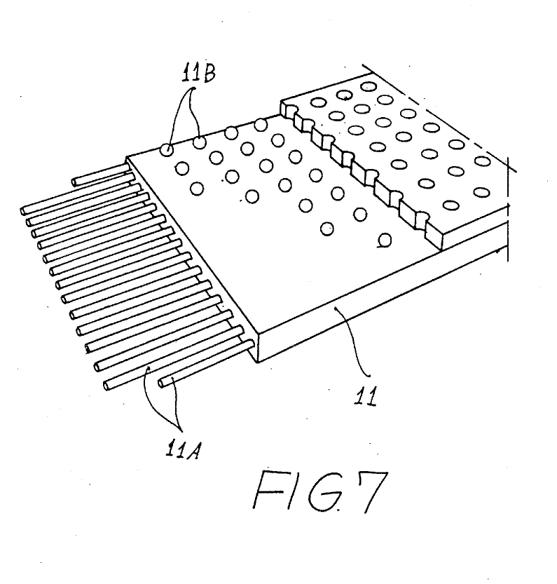

FIG. 6 depicts a similar view to that described in FIG. 5 where, however, the door's mechanical components, which constitute one of this invention privilege patent objects, are shown as an exploded perspective, allowing the visualization of its components separately, but as an ordered relative positioning;

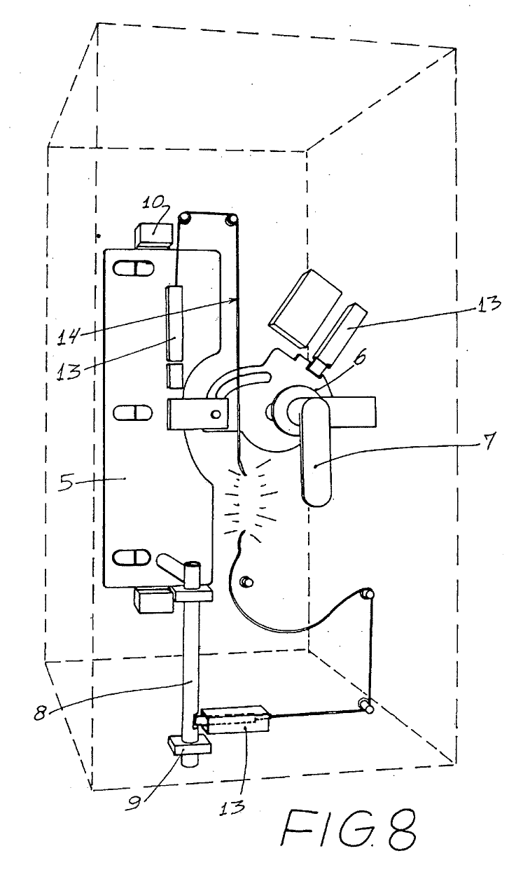

FIG. 7 depicts a detail taken from one of the components incorporated to the improved equipment's door;

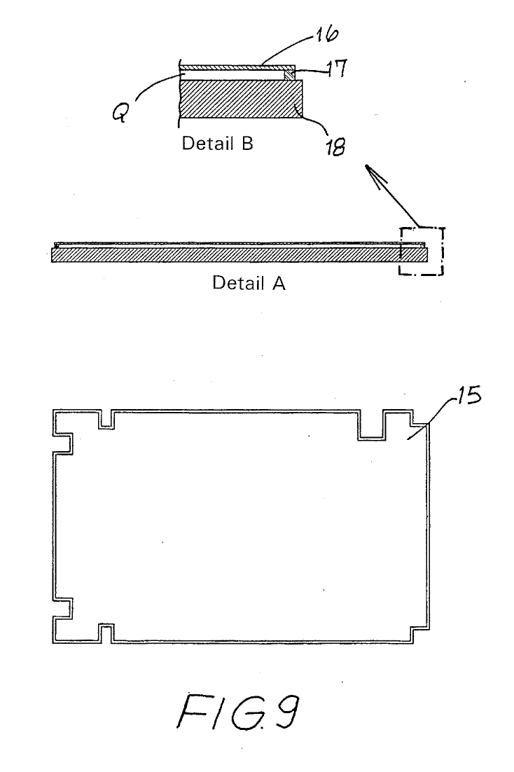

FIG. 8 depicts a situation of the door's safety components activation, as provided in the method described herein;

FIG. 9 depicts a general and plant view of one of the internal armor models, along with the sectioned part (detail A), and an enlarged section (detail B);

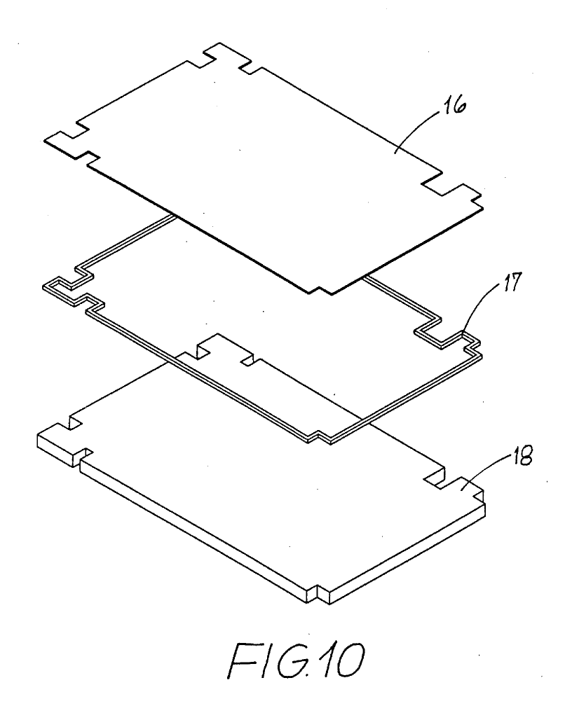

FIG. 10 depicts an exploded view of the above mentioned armor, where its key components can be separately viewed, but at a relative positioning according to a pre-established order;

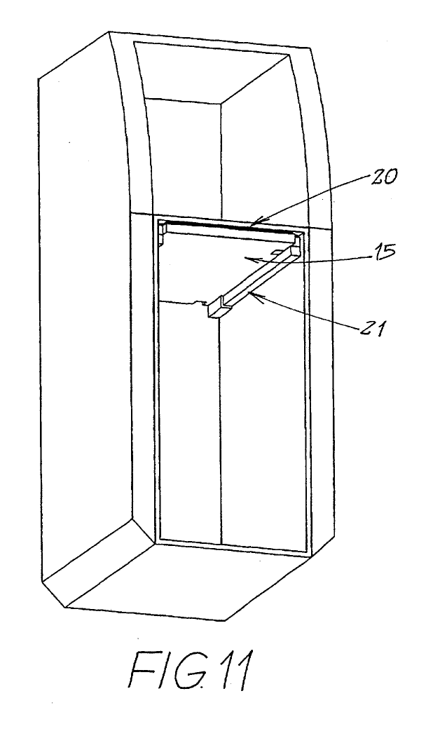

FIG. 11 depicts the above mentioned armor duly applied in an equipment;

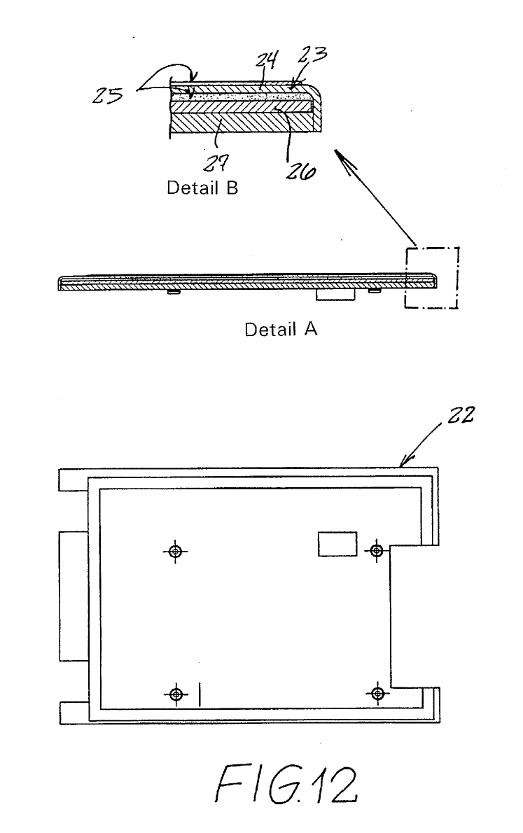

FIG. 12 depicts a general and plant view of another armor model, along with the sectioned view or the respective part (detail A), as well as an enlarged section of the same (detail B);

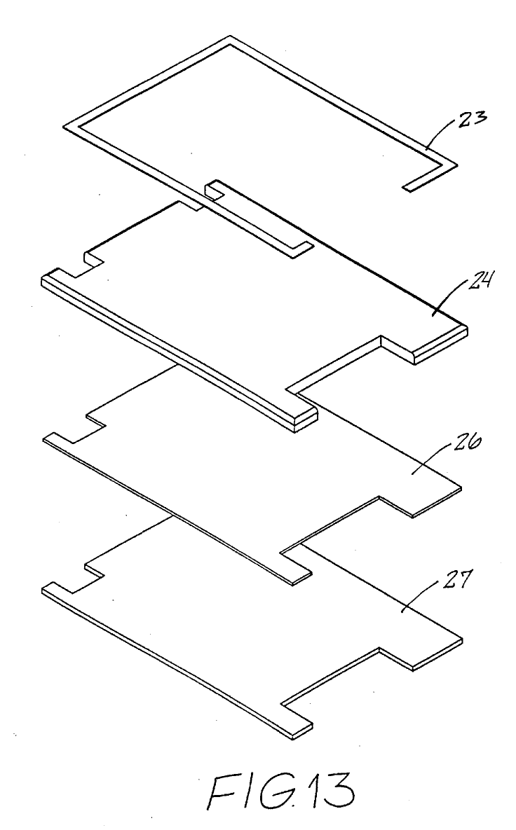

FIG. 13 depicts an exploded view of the above mentioned armor;

FIG. 14 depicts the above mentioned armor installed in an equipment;

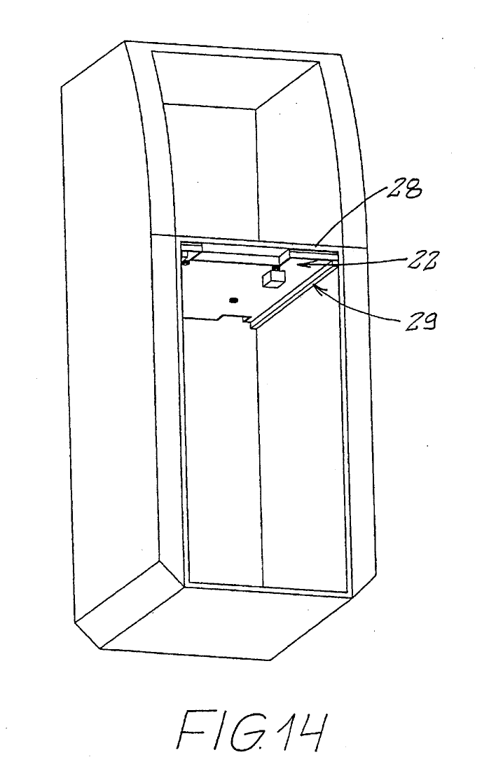

FIG. 15 depicts a general and schematic view of a “Cash Dispenser” type equipment, with the clamping system comprising a base, a clamping set (clamping kit) and an anchorage set (anchorage kit);

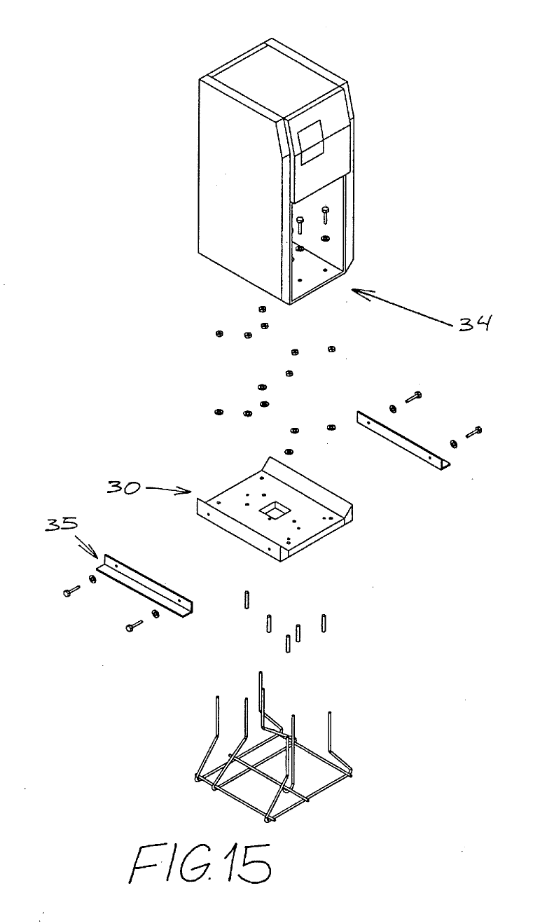

FIG. 16 depicts a general and plant view of the base described in FIG. 15;

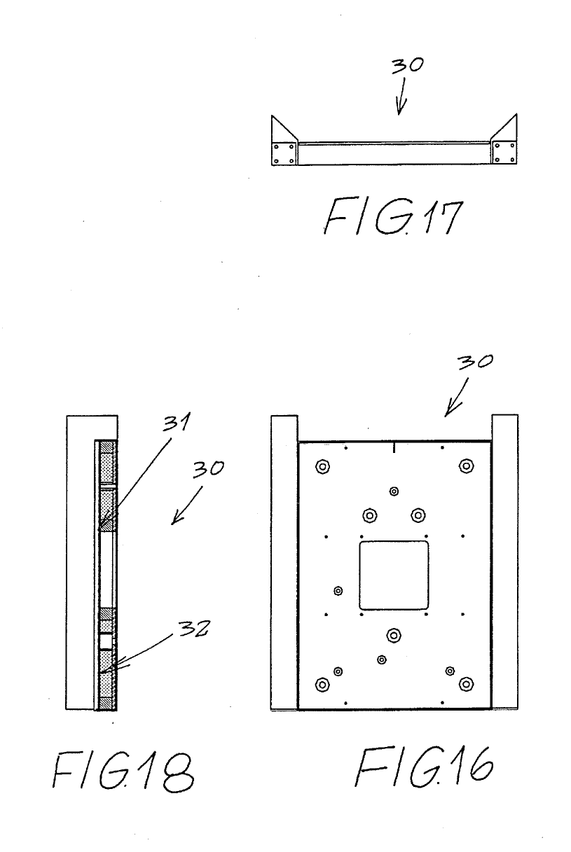

FIG. 17 depicts a view projected from FIG. 16, where the front face of the said base can be viewed; and

FIG. 18 depicts a view which is also projected from the same FIG. 16, where the base side and sectioned face can be noticed, revealing the presence of massive tubes, anchorage and clamping bushings, as well as reinforced concrete.

As depicted by the figures listed above, the reinforcement method addressed herein comprises a serie of devices and mechanical reinforcement elements intended to prevent, as much as possible, the access to the inside of the ATMs and “Cash Dispenser” type equipment, currently available to the public provided by the bank entities operating in our country.

One of this methodology main details, proposed by this Invention Privilege patent, consists in the provision of jackets 1 to be assembled and attached to the equipment's side wall, as it can be better understood by observing FIG. 1.

The installation of the jackets 1, mentioned above, as well as the plates thickness and number of equipment's faces which should receive the said jackets 1, are defined according to the risk level and required safety level, considering the equipment model and, further, the installation conditions.

In a more comprehensive way, the jackets 1 are protective plates installed in the safes and are basically composed by a box 2 made of metal plate, internally coated with materials intended to provide protection against burglary.

The fist material layer contained in the box 2, defining the jacket 1 structure is a chemical compound 3, which provides protection against the effect of a blow torch and the second layer 4, which is preferably made of concrete, thus providing mechanical strength to the parts.

This patent provides further a chemical protection provision constituted in layer number 3, which is essentially made of a flammable compound, containing, preferably, bitumen, pitch and sulfur, in a duly specified layer amounts and thickness. This compound aims to protect the part against the action of blow torches, condition on which the compounds burst into flame thus producing smoke at amount and nature intended to disturb the vision and even the permanence close to the equipment.

In its turn, layer 4, which constitutes the mechanical protection, as provided in this Invention Privilege patent, is preferably obtained from reinforced concrete, containing cement, aluminum oxide with a number of granulations and steel stretched wire, in an specified amount. The said concrete provides high resistance to abrasion and impact, thus providing protection against the action of equipment such as drilling machines and pointers.

Jackets 1 are installed on the walls and/or the equipment's safe door, always in the safe external face, acting as a protection for the equipment's original metal wall. The clamping of these parts is conducted through screws or nuts (or any other appropriate clamping means), through the internal part of the safe, thus limiting the access the clamping elements.

Another approach as provided for in this Invention Privilege patent consists in improving the equipment's door locking mechanisms, in order to provide increased resistance to burglary attempts; therefore, some items are incorporated or modified so that the desired safety level is achieved.

One of the implemented items is the latch bolt 5, which is a mobile part produced with metal plate, responsible for closing and locking the safe when inside its respective strike box.

The horizontal latch bolt 5 movement is obtained by turning (spin) the cam 6, which is driven, in its turn, by the knob 7.

The main latch bolt 5 is connected to the vertical bolt 8, thus moving both of them when activated, being that the said bolt 8, such as it can be better understood by observing FIG. 6, is responsible for locking the safe, when positioned in its respective strike box 9.

Cam 6, in its turn, is the part that prevents the latch bolt 5 from moving, under any condition of applying horizontal stress.

This Invention Privilege patent methodology further envisions the provision of a reinforcement bar 10, which is fixed to the door and is intended to protect the latch bolt in case of burglary

Another item proposed by this Invention Privilege patent is the plate 11, which is produced with reinforced steel and placed in the internal side of the door in the lock's 12 region, thus providing increased mechanical protection in that region.

This Invention Privilege patent further envisions supplementary locking devices 13, which are positioned at strategic points of the doo, such as the cam 6, the latch bolt and bolt 8, as it can be better understood by observing FIG. 8.

In said FIG. 8, it is described the fact that two of the supplementary locking devices 13 are joined by a cable 14, which, upon breaking, immediately causes the bolt 8 and the latch bolt 5 to be locked.

The device 13 connected to the cam 6 is activated in case the equipment's safe door lock is attempted to be violated.

FIG. 7 depicts a detail of plate 11 where it can be noted that it is composed by a frame formed by an arrangement of pins 11A and spheres 11B, which are combined in order to form a single body which is the said plate 11.

The method of this Invention Privilege patent also envisions a set called internal jacket, which is assembled in the equipment's safe internal wall and can have a range in thickness and internal components depending on the equipment's model and the available internal area, as it can be better understood from the figures below.

There is the first model of jacket 15 (FIG. 9), which is preferably composed by a stainless steel plate 16, steel bars 17, which are disposed throughout the stainless steel plate contour, a steel plate 18, positioned under the stainless steel and bar and a chemical protective layer Q between the stainless steel plate and the steel plate, as shown in FIG. 9.

The clamping of the jacket 15 to the equipment is conducted in the internal side of the upper safe 20 plate, being welded throughout its contour, along with stainless steel bars 21 placed under the part, as shown in FIG. 11.

In this Invention Privilege patent, there is also the model of jacket 22, which is composed by a steel plate frame 23, a tray-shape steel plate 24, chemical protective layers Q in the upper and internal parts 25, a refractory material plate 26 and a special steel plate 27, as shown in FIG. 12.

The jacket 22 clamping to the equipment is conducted in the internal side of the upper safe 28 plate, being welded throughout its contour, along with steel bars 29 placed under the part, as shown in FIG. 14.

In a more comprehensive way, the clamping system is basically composed by a base 30 made of metal plate with massive square tubes, which is internally filled with reinforced concrete, aluminum oxide with a number of granulations and steel stretched wire at specified amounts, the said concrete thus provides protection against the effects of actions using equipment such as blow torches, drilling machines and pointers.

A set of trapezoid-shape metal hardware 33, “umbrella handle” type lever and smooth bars which are installed in the bottom of the base through nuts and washers, being these hardware intended to increase the resistance against mechanical strength, once they are installed along with the concrete which anchors the base to the floor where the equipment is to be installed.

Finally, this Invention Privilege patent envisions the set (clamping kit) 34 to anchor the equipment on the base, which is composed by a set of screws with a strength class that is higher than the conventional steel, a set of washers and a set of “pipes” intended to protect the screw thread below the base when concrete is placed. The “pipe” is a part composed by a nut welded to a tube with the close hole positioned under the base and used to protect the screw thread (34); the base is positioned on the floor using the leveling bracket (35).

One of the main functions of the base is to prevent the equipment from being lifted by using manual, hydraulic or any nature or type tools.

When the equipment has a lateral reinforcement, the base should also have the same reinforcement with plate containing concrete in its internal part; in this case, in order to install the base, a set of brackets called leveling brackets, which are fixed to the side of the base through screws and washers, is used. For equipment without lateral reinforcement, called original equipment, the base will not have the supplementary reinforcement and the leveling brackets will not be used as well. The base can be fixed through chemical anchorage; in this case, the anchorage hardware will not be used.

FIGS. 16, 17 and 18 respectively depict general and plant views and details of the base discussed herein.

What we claim is:

1. THE “METHOD FOR BANK EQUIPMENT REINFORCEMENT AND FIXATION THROUGH AN ANCHORAGE BASE”, which is intended for the reinforcement and clamping of ATMS and “Cash Dispensers” type equipment, comprising installing of jackets in the said equipment, being the said jackets protective plates installed in the safes, basically composed by a box made of metal plate, having material layers in its internal part aiming the objective of providing resistance against burglary, and being the first layer of material contained in the box forming the jacket a chemical compound providing resistance against the effects of a blow torch while the second layer is preferably produced with concrete, providing mechanical strength to the parts; the chemical protection which constitutes the layer is, essentially, a flammable compound, preferably containing bitumen, pitch and sulfur in duly specified layer amounts and thicknesses; in its turn, layer, which constitutes the mechanical protection is preferably obtained with reinforced concrete containing cement, aluminum oxide with a number of granulations and steel stretched wires, at the specified amounts.

2. The “METHOD FOR BANK EQUIPMENT REINFORCEMENT AND FIXATION THROUGH AN ANCHORAGE BASE”, according to claim 1, including the fact that the jackets are installed on the walls and/or the equipment's safe door, always in the external face of the safe, acting as a protection for the equipment's original metal wall; the clamping of the jackets is conducted through screws or nuts from the inside of the safe, thus limiting the access to the clamping elements.

3. “METHOD FOR BANK EQUIPMENT REINFORCEMENT AND FIXATION THROUGH AN ANCHORAGE BASE”, comprising improvement of the equipment's door locking mechanisms, by adopting a latch bolt which is a mobile part produced with metal plate and which is responsible for closing and locking the safe when positioned inside its respective strike box; the horizontal movement of the latch bolt is obtained by turning the cam, which is activated by the knob; the main latch bolt is connected to the vertical bolt, providing the movement of both of them when activated; the bolt is responsible for locking the safe, when positioned into its respective strike box; the cam is, in its turn, the part which prevents the latch bolt from moving under any horizontal strength condition.

4. “METHOD FOR BANK EQUIPMENT REINFORCEMENT AND FIXATION THROUGH AN ANCHORAGE BASE”, comprising a reinforcement bar, which is fixed to the door and is intended to protect the latch bolt in case of burglary.

5. “METHOD FOR BANK EQUIPMENT REINFORCEMENT AND FIXATION THROUGH AN ANCHORAGE BASE”, comprising a plate, which is preferably produced with reinforced steel, being placed inside the door in the region of the lock, thus providing increased mechanical protection to this region; the plate is composed by a structure formed by an arrangement of pins.

6. “METHOD FOR BANK EQUIPMENT REINFORCEMENT AND FIXATION THROUGH AN ANCHORAGE BASE”, comprising the installation of jackets inside ATM and “Cash Dispenser” type equipment, being that the jacket is composed by a plate preferably made of stainless steel, steel bars, which are disposed throughout the stainless steel plate contour, a steel plate, placed below the stainless steel and bar set providing mechanical strength to the part and a chemical protective layer defined by a flammable compound containing, bitumen, pitch and sulfur at the specified amount and thickness, disposed between the stainless steel plate and the steel plate; in an internal jacket model it is composed by a steel plate frame, a tray-shape steel plat, chemical protective layers defined by a flammable compound containing, bitumen, pitch and sulfur at the specified amount and thickness, in the upper and internal part, a refractory material plate and a special steel plate, completing the set of plates providing mechanical strength to the part.

7. “METHOD FOR BANK EQUIPMENT REINFORCEMENT AND FIXATION THROUGH AN ANCHORAGE BASE”, according to claim 1, comprising the fact that the jackets are always installed on the internal and upper walls of the safe; the clamping of such jackets is through welding throughout its contour with the reinforcement help of steel bars.

8. “METHOD FOR BANK EQUIPMENT REINFORCEMENT AND FIXATION THROUGH AN ANCHORAGE BASE” comprising providing the installation in ATM and “Cash Dispenser” type equipment using a clamping system through the metal base, being the base constituted by metal plates with massive tubes internally containing a material intended to provide resistance against the attack to the base through blow torches, drilling machines and pointers, being that such material constitutes the mechanical protection obtained in reinforced concrete containing cement, aluminum oxide with a number of granulations and steel stretched wires, at the specified amounts; the base is fixed to the floor through a set of trapezoid-shape hardware, “umbrella handle” type lever and smooth bars called anchorage and the equipment is fixed to the base through a set of screws with mechanical strength class that is superior to conventional steel, washers and “pipe”, which is a part composed by a nut welded to a tub with the closed hole positioned under the base and used to protect the screw thread, the base is positioned on the floor using the leveling bracket.
